(19) United States
(12) Patent Application Publication
(10) Pub. No.: US 2021/0304299 A1
(43) Pub. Date: Sep. 30, 2021

(54) COMPLEX SOURCING SYSTEM WITH INFEASIBILITY CHECK

(71) Applicant: Zycus Infotech Pvt. Ltd., Mumbai (IN)

(72) Inventors: Sarang Kulkarni, MUMBAI (IN); Nageswara Reddy Kondreddy, MUMBAI (IN); Chitra Kashyap, MUMBAI (IN); Kanishka Ghosh, MUMBAI (IN)

(73) Assignee: Zycus Infotech Pvt. Ltd., Mumbai (IN)

(21) Appl. No.: 17/206,673

(22) Filed: Mar. 19, 2021

(30) Foreign Application Priority Data
Mar. 26, 2020 (IN) 202021013128

(51) Int. Cl. G06Q 30/08; G06Q 10/08

(52) U.S. Cl. CPC G06Q 30/08; G06Q 10/087

(57) ABSTRACT

A complex sourcing system that collects data from bidders. The information which is collected from the suppliers is interpreted by applying several business constraints including supplier award value criteria, supplier award volume criteria, etc. on it for the selection of an optimal supplier for the allocation of lanes. A user will create a scenario with collection of these business constraints. Once the scenario is created and while solving it, there might be a situation where the specified constraints cannot be satisfied and conflict. At this point, there is a need to identify the root cause of the infeasibility and repair it. For this, a priority of constraints will be provided by the user on scenario creation page. Based on the priority, the solver will auto correct/eliminate the constraints and return the feasible solution along with the set of constraints that are removed.

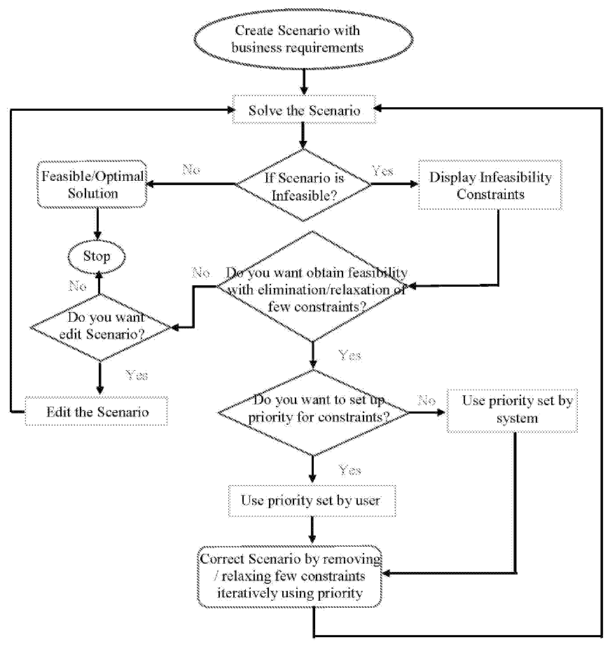

### CROSS-REFERENCE TO RELATED APPLICATION

The instant application claims priority to Indian Patent Application Serial No. 202021013128, filed Mar. 26, 2020, pending, the entire specification of which is expressly incorporated herein by reference.

### FIELD OF THE INVENTION

The present invention relates to a complex sourcing system for implementing different permutations and combinations based on several different business constraints for optimal analysis, sourcing, multi-level negotiation, contracting, procurement and payment and to identify the root cause of the infeasibility and repair any conflictions situations.

### BACKGROUND OF THE INVENTION

Logistics plays an important role in integrating the supply chain of industries. Because the market is becoming more global, logistic companies play an important role in the industry by decreasing the cost and increasing the customer service quality.

The logistic companies have to spend a considerable amount of time and resources in preparing and executing of a bid, before the final selection of the supplier. These companies act as a connecting link or bridge between the buyer/companies and the supplier. The logistic companies first of all gets a list of supplier's selection criteria like cost related factors, discounts offered by the suppliers etc. after which an auction is executed wherein the suppliers provide information as requested from them and the supplier whose inputs are most suitable is selected. Thereafter, the supplier is allocated the lanes and a contract between the Buyer and the Supplier is executed.

Since, these logistic companies have to make shipments across different regions. These logistic companies find it very difficult to conduct bidding of these lanes and to apply different permutations and combinations of different lanes across different regions to be allotted to different suppliers in case of a large event wherein there are thousands of lanes in different regions for which number of suppliers are bidding. When the users or buyers apply different business constraints using different permutations and combinations across hundreds of different lanes for shipment for awarding to different suppliers, it is quite possible that there might be some conflicting situation within business constraints for execution.

U.S. Pat. No. 6,915,268 discloses a logistics system and method operated by a third-party intermediary for management of shipment of goods supplied from plurality of different suppliers by plurality of different carriers. This system does not provide a method to choose an optimal supplier by way of e-auction with live monitoring and does not provide multi level negotiation feature. The system is also not workable for very large events. Neither the system provides a mechanism to check the infeasibility of business constrains and method to correct them.

### Definition

The expression “infeasibility” used hereinafter in this specification refers to, but is not limited to a scenario which is said to be infeasible (i.e., no feasible solution exists) if there exists no solution that can satisfy all business requirements of the scenario.

### OBJECTS OF THE INVENTION

The primary object of the present invention is to provide a novel system and method for the selection of a supplier for allocation of lanes.

Yet another object of the present invention is to identify the root cause of the infeasibility and repair (remove or relax) any conflicts in the business constraints.

### SUMMARY OF THE INVENTION

Before the present invention is described, it is to be understood that the present invention is not limited to specific methodologies and materials described, as these may vary as per the person skilled in the art. It is also to be understood that the terminology used in the description is for the purpose of describing the particular embodiments only and is not intended to limit the scope of the present invention.

The present invention provides a complex sourcing system that collects data from bidders. The information which is collected from the suppliers is interpreted by applying several business constraints on it for the selection of an optimal supplier. The complex sourcing system can use number of constraints to select the optimal supplier for the allocation of lanes. These business constrains include supplier award value criteria, supplier award volume criteria, tiered award allocation-supplier count criteria, tiered award allocation-supplier award quantity criteria, supplier capacity criteria, supplier count criteria, bundle bidding criteria, discount bidding criteria and item group-based criteria, and environment compliance criteria. A user will create a scenario with collection of business constraints. Once the scenario is created and while solving it, there might be a situation where the specified constraints cannot be satisfied and conflict. At this point, there is a need to identify the root cause of the infeasibility and repair (remove or relax) it. For this, a priority of constraints will be provided by the user on scenario creation page. Based on the priority, the solver will auto correct/eliminate the constraints and return the feasible solution along with the set of constraints that are removed.

### BRIEF DESCRIPTION OF THE DRAWINGS

The present invention, together with further objects and advantages thereof, is more particularly described in conjunction with the accompanying drawings in which:

The FIGURE shows a flowchart illustrating the process of the present invention.

### DETAILED DESCRIPTION OF THE INVENTION

Before the present invention is described, it is to be understood that this invention is not limited to particular methodologies described, as these may vary as per the person skilled in the art. It is also to be understood that the terminology used in the description is for the purpose of describing the particular embodiments only, and is not intended to limit the scope of the present invention. Throughout this specification, the word “comprise”, or variations such as “comprises” or “comprising”, will be understood to imply the inclusion of a stated element, integer or step, or group of elements, integers or steps, but not the exclusion of any other element, integer or step, or group of elements, integers or steps. The use of the expression “at least” or “at least one” suggests the use of one or more elements or ingredients or quantities, as the use may be in the embodiment of the invention to achieve one or more of the desired objects or results. Various embodiments of the present invention are described below. It is, however noted that the present invention is not limited to these embodiments, but rather the intention is that modifications those are apparent are also included.

In the present invention, a complex sourcing system is used for analysing any large event, which is difficult to be done manually and is not merely cherry picking of constraints and selecting the suppliers. The complex sourcing system of the present invention is very useful for the logistics companies to conduct bidding of thousands of lanes for making shipment across thousands of regions.

In the present invention, the complex sourcing system collects data from bidders. The information which is collected from the suppliers is interpreted by applying several business constraints on it for the selection of an optimal supplier.

The complex sourcing system can use number of constraints to select the optimal supplier for the allocation of lanes. The two broad level business constraints used in the present invention are given below:

Minimization of cost related business constraints: In this category of constraints, the system applies all the business constraints that can be incorporated as a part of the complex sourcing system. The customers can configure all or any of the constraints which are mentioned below while creating award scenarios. The business constraint model runs these business constraint criteria in various permutations and combinations. Some of these business constraint criteria also contain sub-criteria which help in defining the limits of the criteria. All the business constraints that can be incorporated as a part of the complex sourcing system are as follows:

Supplier award value criteria: It describes the total business amount in the event currency allocated to the supplier. It has two sub criteria:

Minimum award value (absolute value or percentage) per supplier; and

Maximum award value (absolute value or percentage).

Supplier award volume criteria: It describes the total number of lanes allocated to each supplier. It has two sub criteria:

Minimum number of supplier per lane; and

Maximum number of supplier per lane.

Tiered award allocation-supplier count criteria: This criterion is meant to define the number of suppliers amongst whom the total business of the lane should be divided. It contains a primary use case scenario which can be used in case the buyer wants to allocate business to a primary and secondary carrier per lanes. It has two sub criteria:

Minimum number of supplier per lane; and

Maximum number of supplier per lane.

Tiered award allocation-supplier award quantity criteria: This criterion defines the allocation of a single item (lane) to a primary or secondary supplier in a specified proportion. It has two sub criteria:

Quantity award percentage to be allocated to the primary supplier (e.g., 80%); and

Quantity award percentage to be allocated to the secondary supplier (e.g., 20%).

Supplier capacity criteria: This criterion will allocate the business volume of a lane to a supplier based on the supplier proposed quantity. The volume awarded to a supplier will not exceed capacity of the supplier. It has one sub criterion:

Supplier proposed volume for each lane (this is input as a part of the supplier response).

Supplier count criteria: This criterion will allocate the total business amongst a specific number of suppliers. It has three sub criteria:

Minimum supplier count for the award scenario;

Maximum supplier count for the award scenario; and

Exact supplier count for the award scenario.

Bundle bidding criteria: The criteria give an option to the suppliers to provide additional discount on a group of items if the items are allocated to them in the award scenario. The criteria will take the bundled bids submitted by the supplier into account while applying the optimization processing means.

Discount bidding criteria: The criteria gives an option to the suppliers to provide additional discount on an item if a specific percentage of the award volume (usually equal or greater than the designated percentage) for the item is allocated to them in the award scenario. The criteria will take the discount bids submitted by the supplier into account while applying the optimization processing means.

Item group-based criteria: These criteria can be applied when a selection of items is grouped together based on some single or multiple parameters. The user defines a supplier group from which the awardees for the items must be picked. This will be considered by the optimization processing means while making the award. For example, all the lanes originating from Madrid should be awarded from the supplier group A, B, C.

Another category of important business constraint includes the environmental compliance constraints especially carbon emission threshold check criteria. In this set of constraints, the buyer will set carbon emission related business constraint for each set of lanes and for each region. The suppliers will provide inputs to these aspects in the RFI and accordingly the selection of the suppliers will be based on the fulfilment of these constraints along with other business cost saving constraints.

In addition to the above-mentioned broad categories of business constraints, the complex sourcing system also considers the discount based criteria which describe the discounts offered by supplier for selecting the right permutations and combinations of suppliers for the lanes. The suppliers may offer bundle discounts for example, supplier 1 may offer 10% discounts if 500 lanes of x-region are allotted to him by the buyer. The system takes into consideration these discount offers before the allocation of the award.

In the present invention, user will create a scenario with collection of business requirements referred as constraints. Once the scenario is created and while solving it, there might be a situation where the specified constraints cannot be satisfied and conflict. At this point, there is a need to identify the root cause of the infeasibility and repair (remove or relax) it. For this, a priority of constraints will be provided by the user on scenario creation page. Based on the priority, the solver will auto correct/eliminate the constraints and return the feasible solution along with the set of constraints that are removed. For detail understanding, a flowchart is illustrated.

For example, consider a scenario where the constraints Tiered Award Allocation: Supplier Count, Tiered Award Allocation: Supplier Award Quantity, Supplier Count Constraint are conflicting each other and causing infeasibility. At this point, the user is interested to see feasibility with elimination/relaxation of few constraints and provided the priority of constraints as below to correct the scenario (starting from low priority and ending with high priority). If a constraint has lower priority, it gets eliminated/relaxed firstly compared to a constraint having higher priority.

In the present invention, a user can create different scenarios. Each scenario is defined by a collection of business requirements referred as constraints. A constraint may have different iterations e.g., Tiered award allocation: supplier count constraint can be defined for individual lanes. Hence, the constraint for each lane is treated as a different iteration of the constraint Tiered award allocation: supplier count (e.g., see Table, below).

TABLE

| Priority | Constraint | Elimination/relaxation order |
|---|---|---|
| High | Tiered Award Allocation: | 3 |
| | Supplier Count | |
| Medium | Supplier Count Constraint | 2 |
| Low | Tiered Award Allocation: | 1 |
| | Supplier Award Quantity | |

To remove the infeasibility in the above-mentioned scenario, first we will eliminate/relax the constraint with low priority and solve the scenario for feasibility. Once the feasibility is obtained, the scenario will terminate with feasible or optimal solution, if not the above procedure repeats till feasibility obtains.

The infeasibility is detected at ‘iteration’ level using a rule-based algorithm. First, the constraints are classified in different infeasibility sets. Each infeasibility set consists of different constraints that can possibly conflict with each other. A constraint can be present in more than one infeasibility set. Next, the algorithm will carefully evaluate values for all the constraints in each set and detect the infeasibility if any.

Mathematically it is impossible to find the infeasibility. The system defines solution is infeasible. Further, to check which constrain or set of constrains is infeasible and to resolve it, is difficult. Therefore, identification of the constraints is important by relaxing the check criteria.

There can be multiple iterations—like combination of constraints, business discounts offered conditions, carbon emission aspects and other compliances or only one constraint. Auto optimization is also possible.

Below are two examples of infeasibility sets, as well as the infeasibility induced due to the values set by the user.

### Example 1

Tiered award allocation is selected, for example, supplier count, where minimum number of suppliers per lane and maximum number of suppliers per lane are used. Supplier count is calculated for the minimum number of suppliers for the event, maximum number of suppliers for the event and the exact number of suppliers for the event.

In the above example, the scenario will be infeasible if:

1. Minimum number of suppliers for lane ‘L1’ and ‘L2’ are set at 4 and 3, respectively in tiered award allocation: supplier count constraint.

2. Exact number of suppliers for the event is set at 3 in supplier count constraints.

User will be suitably notified that the scenario is infeasible due to tiered award allocation: supplier count constraint for ‘L1’ and supplier count constraint.

### Example 2

Tiered award allocation is selected, for example, supplier count, where minimum number of suppliers per lane and maximum number of suppliers per lane are used. Supplier quantity is calculated for the percentage of total allocated spend for primary and secondary suppliers and percentage of total allocated spend for primary, secondary and tertiary suppliers

In the above example, the scenario will be infeasible if:

1. Minimum number of suppliers for lane ‘L1’ and ‘L2’ are set at 3 and 2, respectively, in tiered award allocation: supplier count constraint.

2. 80% of total allocated spend to primary supplier and 20% of the total allocated spend to secondary supplier.

User will be suitably notified that the scenario is infeasible due to tiered award allocation: supplier count constraint for ‘L1’ and tiered award allocation: supplier quantity constraint.

In some applications, the present invention described above may be provided as elements of an integrated software system, in which the features may be provided as separate elements of a computer program. Some embodiments may be implemented, for example, using a computer-readable storage medium (e.g., non-transitory) or article which may store an instruction or a set of instructions that, if executed by a processor, may cause the processor to perform a method in accordance with the embodiments. Other applications of the present invention may be embodied as a hybrid system of dedicated hardware and software components. Moreover, not all of the features described above need be provided or need be provided as separate units. Additionally, it is noted that the arrangement of the features do not necessarily imply a particular order or sequence of events, nor are they intended to exclude other possibilities. For example, the features may occur in any order or substantially simultaneously with each other. Such implementation details are immaterial to the operation of the present invention unless otherwise noted above.

The exemplary methods and computer program instructions may be embodied on a computer readable storage medium (e.g., non-transitory) that may include any medium that can store information. Examples of a computer readable storage medium (e.g., non-transitory) include electronic circuits, semiconductor memory devices, ROM, flash memory, erasable ROM (EROM), floppy diskette, CD-ROM, optical disk, hard disk, fiber optic medium, or any electromagnetic or optical storage device. In addition, a server or database server may include computer readable media configured to store executable program instructions. The features of the embodiments of the present invention may be implemented in hardware, software, firmware, or a combination thereof and utilized in systems, subsystems, components or subcomponents thereof.

Furthermore, a software program embodying the features of the present invention may be used in conjunction with a computer device or system. Examples of a computing device or system may include, but are not limited to, an electronic book reading device, a computer workstation, a terminal computer, a server computer, a handheld or mobile device (e.g., a tablet computer, a personal digital assistant “PDA,” a mobile telephone, a Smartphone, etc.), a web appliance, a network router, a network switch, a network bridge, any machine capable of executing a sequence of instructions that specify an action to be taken by that machine, and any combinations thereof. In one example, a computing device may include and/or be included in, a kiosk.

As used herein, the term “mobile device” is intended to encompass any form of programmable computing device as may exist, or will be developed in the future, that implements a communication module for wireless voice and data communications, including, for example, cellular telephones, personal data assistants (PDA's), palm-top computers, laptop, and notebook computers, wireless electronic mail receivers the BLACKBERRY™ and TREO™ devices multimedia Internet enabled cellular telephones (e.g., the BLACKBERRY STORM™, and similar personal electronic devices that include a wireless communication module, processor and memory.

The computer device or system may also include an input device. In one example, a user of the computer device or system may enter commands and/or other information into computer device or system via an input device. Examples of an input device may include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), touchscreen, and any combinations thereof. The input device may be interfaced to bus via any of a variety of interfaces including, but not limited to, a serial interface, a parallel interface, a game port, a USB interface, a FIREWIRE interface, a direct interface to bus, and any combinations thereof. The input device may include a touch screen interface that may be a part of or separate from the display.

A user may also input commands and/or other information to the computer device or system via a storage device (e.g., a removable disk drive, a flash drive, etc.) and/or a network interface device. A network interface device, such as network interface device may be utilized for connecting the computer device or system to one or more of a variety of networks and/or one or more remote devices connected thereto. Examples of a network interface device may include, but are not limited to, a network interface card (e.g., a mobile network interface card, a LAN card), a modem, and any combination thereof. Examples of a network may include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software, etc.) may be communicated to and/or from the computer device or system via a network interface device.

The computer device or system may further include a video display adapter for communicating a displayable image to a display device, such as a display device. Examples of a display device may include, but are not limited to, a liquid crystal display (LCD), a cathode ray tube (CRT), a plasma display, a light emitting diode (LED) display, and any combinations thereof. In addition to a display device, the computer device or system may include one or more other peripheral output devices including, but not limited to, an audio speaker, a printer, and any combinations thereof. Such peripheral output devices may be connected to a bus via a peripheral interface. Examples of a peripheral interface may include, but are not limited to, a serial port, a USB connection, a FIREWIRE connection, a parallel connection, and any combinations thereof.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A complex sourcing system for managing the bidding and allocation of different lanes to different suppliers in different regions, wherein the system is enabled to select the optimal supplier by processing the information and running different business constraints and compliance related constraints tests on the information, wherein the business constraints include supplier award value criteria, supplier award volume criteria, tiered award allocation-supplier count criteria, tiered award allocation-supplier award quantity criteria, supplier capacity criteria, supplier count criteria, bundle bidding criteria, discount bidding criteria and item group-based criteria, environment compliance criteria in various permutations and combinations, wherein the system identifies the cause of infeasibility of the business constrains in certain conflicting situations and provides a solution to repair the conflicting situations.

2. The system as claimed in claim 1, further comprising a priority of constraints by the user on a scenario creation page.

3. The system as claimed in claim 1, wherein the system, based on the priority, auto corrects or eliminates the constraints and return the feasible solution along with a set of constraints that are removed.

4. The system as claimed in claim 1, wherein the system eliminates or relaxes a constraint having a lower priority first as compared to a constraint having a higher priority.

5. The system as claimed in claim 1, wherein once the feasibility is obtained, the system will terminate the scenario with a feasible or optimal solution, and if not, then the above procedure repeats until feasibility is obtained.
